(19) United States
(12) Patent Application Publication
(10) Pub. No.: US 2019/0085964 A1
(43) Pub. Date: Mar. 21, 2019

(54) TRANSMISSION AND ACTUATOR

(71) Applicant: Nidec Corporation, Kyoto (JP)

(72) Inventors: Wataru YAMAUCHI, Kyoto (JP); Akihiro TODA, Kyoto (JP); Teiichi HIRONO, Kyoto (JP); Yuko SAKAMOTO, Kyoto (JP)

(21) Appl. No.: 16/122,914

(22) Filed: Sep. 6, 2018

Related U.S. Application Data
(60) Provisional application No. 62/559,026, filed on Sep. 15, 2017.

(30) Foreign Application Priority Data
May 29, 2018 (JP) 2018-102581

(51) Int. Cl. F16H 49/00

(52) U.S. Cl. CPC F16H 49/001

(57) ABSTRACT

A transmission includes a first shaft rotatable in a circumferential direction about a central axis extending in one direction, a second shaft rotatable in the circumferential direction and in series with the first shaft in an axial direction in which the central axis extends, an internal gear including an internal tooth portion, a housing that houses the internal gear therein, an annular external gear connected to the second shaft and including an external tooth portion that partially meshes with the internal tooth portion, a cam that is rotatable together with the first shaft, and includes a connection hole that houses a portion of the first shaft, and a bearing between an inner circumferential surface of the external gear and an outer circumferential surface of the cam. The cam includes an inner circumferential surface defining the connection hole and a recessed portion recessed in radial directions centered on the central axis. At least a portion of the recessed portion is opposite to the external tooth portion in the radial directions.

### CROSS REFERENCE TO RELATED APPLICATIONS

This application claims the benefit of priority to U.S. patent application Ser. No. 62/559,026 filed on Sep. 15, 2017 and Japanese Patent Application No. 2018-102581 filed on May 29, 2018. The entire contents of these applications are hereby incorporated herein by reference.

### BACKGROUND OF THE INVENTION

### 1. Field of the Invention

The present invention relates to a transmission and an actuator.

### 2. Description of the Related Art

JP-A 2005-308131 describes a cup-shaped strain wave gearing device including a rigid internal gear, a cup-shaped flexible external gear arranged coaxially inside of the rigid internal gear, and a wave generator having an elliptical contour and fitted inside of the flexible external gear. The wave generator of the cup-shaped strain wave gearing device includes a cam plate having an elliptical contour, a plug to which the cam plate is coaxially fixed, and a wave bearing attached to an outer circumferential surface of the cam plate. A shaft hole, in which an input shaft can be inserted and fixed, is defined in a center of the plug.

When the input shaft is press fitted into the shaft hole of the plug, the shape of an outer circumference of the input shaft can be transferred to the plug to deform an outer circumferential portion of the plug. The flexible external gear is deformed in accordance with the shape of the outer circumferential portion of the plug, and therefore, a deformation of the outer circumferential portion of the plug might lead to a deterioration in accuracy with which the rigid internal gear and the flexible external gear mesh with each other.

### SUMMARY OF THE INVENTION

A transmission according to a preferred embodiment of the present invention includes a first shaft that is rotatable in a circumferential direction about a central axis extending in one direction; a second shaft that is rotatable in the circumferential direction, and arranged in series with the first shaft in an axial direction in which the central axis extends; an internal gear including an internal tooth portion; a housing that houses the internal gear therein; an annular external gear connected to the second shaft, and including an external tooth portion that partially meshes with the internal tooth portion; a cam that is rotatable together with the first shaft, and including a connection hole that houses a portion of the first shaft; and a bearing located between an inner circumferential surface of the external gear and an outer circumferential surface of the cam. The cam includes an inner circumferential surface defining the connection hole, and including a recessed portion recessed in radial directions centered on the central axis. At least a portion of the recessed portion is opposite to the external tooth portion in the radial directions.

An actuator according to a preferred embodiment of the present invention includes the transmission according to a preferred embodiment of the present invention and a rotary electric machine connected to one of the first shaft and the second shaft.

Preferred embodiments of the present invention are able to reduce the likelihood of a deformation of the cam, and reduce the likelihood of a deterioration in accuracy with which the internal gear and the external gear mesh with each other.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view illustrating an external structure of an actuator according to a preferred embodiment of the present invention.

FIG. 2 is a side sectional view of an actuator according to a preferred embodiment of the present invention.

FIG. 3 is a perspective view illustrating an example exterior of a cam according to a preferred embodiment of the present invention.

FIG. 4 is a perspective view illustrating an example exterior of an external gear according to a preferred embodiment of the present invention.

FIG. 5 is a perspective view illustrating an example exterior of an internal gear according to a preferred embodiment of the present invention.

FIG. 6 is a partial side sectional view illustrating a structure of a gear mechanism of a speed reducer according to a preferred embodiment of the present invention in an enlarged form.

FIG. 7 is a partial side sectional view illustrating a structure of a gear mechanism of a speed reducer according to a first modification of a preferred embodiment of the present invention in an enlarged form.

FIG. 8 is a partial side sectional view illustrating the structure of a gear mechanism of a speed reducer according to a second modification of a preferred embodiment of the present invention in an enlarged form.

FIG. 9 is a partial side sectional view illustrating a structure of a gear mechanism of a speed reducer according to a third modification of a preferred embodiment of the present invention in an enlarged form.

FIG. 10 is an exploded perspective view illustrating a structure of a first shaft of a speed reducer according to a fourth modification of a preferred embodiment of the present invention.

FIG. 11 is a partial side sectional view illustrating a structure of a gear mechanism of a speed reducer according to a fifth modification of a preferred embodiment of the present invention in an enlarged form.

FIG. 12 is an exploded perspective view illustrating an example structure of a flexible shaft coupling according to the fifth modification of a preferred embodiment of the present invention.

### DETAILED DESCRIPTION OF THE PREFERRED EMBODIMENTS

Hereinafter, preferred embodiments of the present invention will be described in detail with reference to the accompanying drawings.

1. Overall Structure of Actuator

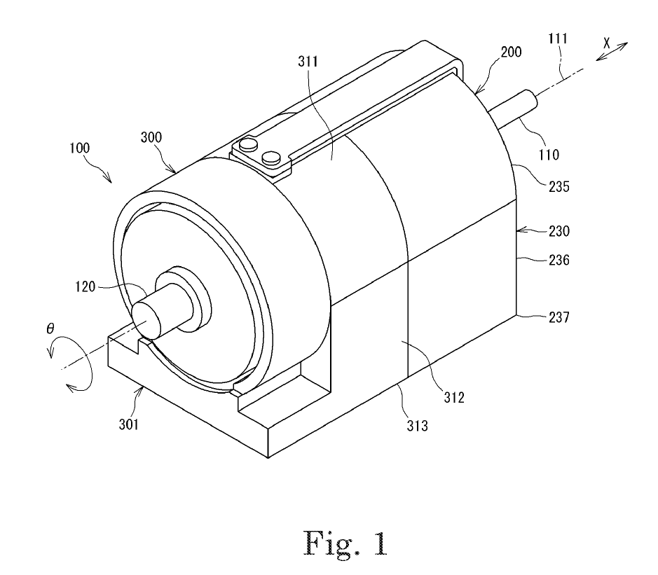

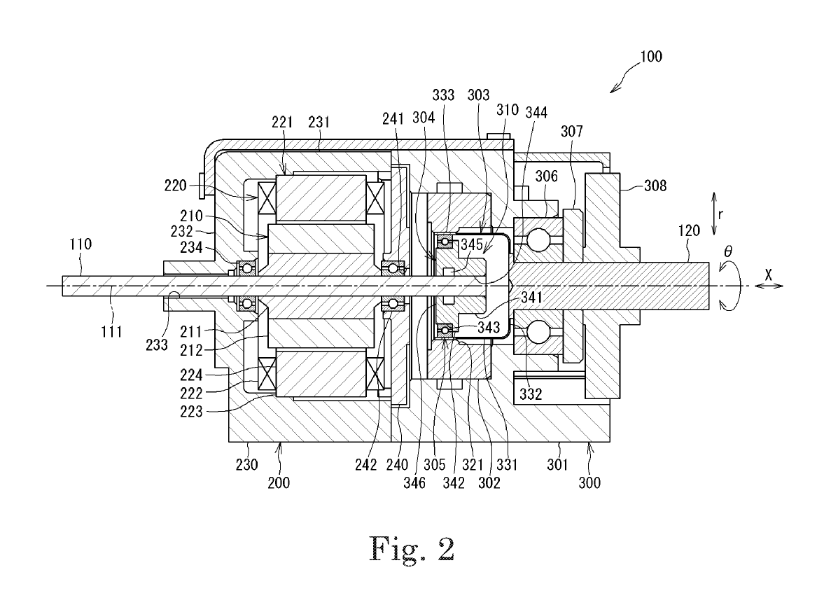

FIG. 1 is a perspective view illustrating the external structure of an actuator 100 according to a preferred embodiment of the present invention. FIG. 2 is a side sectional view of the actuator 100 according to the present preferred embodiment. Referring to FIGS. 1 and 2, the actuator 100 includes a motor (i.e., a rotary electric machine) 200 and a speed reducer (i.e., a transmission) 300. Note that the rotary electric machine may not necessarily be a motor, but may alternatively be an electric generator or a motor generator, which is able to function as both a motor and an electric generator. Also note that the transmission may not necessarily be a speed reducer, but may alternatively be a speed increaser.

2. Structure of Motor

The structure of the motor 200 will now be described below with reference to FIG. 2. The motor 200 is arranged to rotate a first shaft 110, which is a rotating shaft. The motor 200 includes a rotor 210 fixed to the first shaft 110, and a stator 220 arranged in the shape of a circular ring around the rotor 210. In this preferred embodiment, the rotor 210 is a field component, while the stator 220 is an armature. Note that the rotor 210 and the stator 220 may alternatively be an armature and a field component, respectively. It is assumed in the following description that an axial direction in which a central axis 111 of the first shaft 110 extends is an “x direction”, that a circumferential direction about the central axis 111 is a “θ direction”, and that radial directions centered on the central axis 111 are each an “r direction”.

The rotor 210 includes a cylindrical yoke 211, and a permanent magnet 212 fixed to an outer circumferential surface of the yoke 211. A portion of the first shaft 110 extending in the x direction is housed in the yoke 211, and the yoke 211 is fixed to the first shaft 110. The permanent magnet 212 is arranged on an outer circumference of the yoke 211. The permanent magnet 212 is a ring magnet including south and north poles arranged to alternate with each other in the e direction, and arranged at regular intervals in the e direction. Each magnetic pole of the permanent magnet 212 is arranged on a surface facing outward in an r direction, i.e., on a surface facing the stator 220.

The stator 220 includes a core 221 and a plurality of coils 222. The core 221 is made of a soft magnetic material, and includes a plurality of teeth 224. The teeth 224 are arranged at regular intervals in the e direction. Each tooth 224 is arranged to extend in an r direction toward the central axis 111. The number of coils 222 and the number of teeth 224 are equal to each other.

The number of coils 222, that is, the number of slots, is different from the number of poles of the permanent magnet 212. In the case of a three-phase motor, for example, the number of slots is a multiple of three, and the number of poles is an even number

The motor 200 further includes a casing 230 and a cover 240. The casing 230 includes a tubular portion 231 and a plate-shaped cover portion 232. The tubular portion 231 has a columnar space defined inside thereof, and one end of the tubular portion 231, i.e., an end portion of the tubular portion 231 in the x direction in the example of FIG. 2, is closed by the cover portion 232. The casing 230 is that houses the rotor 210 and the stator 220.

The tubular portion 231 of the casing 230 is arranged to have an inside diameter substantially equal to an outside diameter of the core 221. The core 221 is fixed to an inner circumferential surface of the tubular portion 231 through, for example, an adhesive. The stator 220 is thus fixed to an inner circumferential surface of the casing 230. The cover portion 232 includes a circular hole 233 defined in a center thereof in the r directions. The hole 233 is arranged to have a diameter greater than that of the first shaft 110, and the first shaft 110 is arranged to pass through the hole 233. A bearing 234 in the shape of a circular ring is fitted around the hole 233, and the bearing 234 is arranged to rotatably support the first shaft 110.

The casing 230 is arranged to have an external shape being a combination of a semicircle and a rectangle when viewed in the x direction. In other words, the casing 230 includes a semicircular portion 235 and a flange portion 236, which are semicircular and rectangular, respectively, when viewed in the x direction. A semicircular exterior of the semicircular portion 235 is arranged to be concentric with an inner circumferential surface of the semicircular portion 235. That is, the exterior of the semicircular portion 235 is an arc-shaped surface which is semicircular with the central axis of the first shaft 110 as a center. Meanwhile, the flange portion 236 includes two right-angled corner portions 237 each of which projects in an r direction, and the flange portion 236 is joined to the speed reducer 300 through bolts at the corner portions 237.

The cover 240 is a circular plate having a diameter slightly greater than that of a circular opening of the casing 230. The cover 240 is fixed at the opening of the casing 230 to close the opening. The cover 240 includes a circular hole 241 defined in a center thereof in the r directions. A bearing 242 in the shape of a circular ring is fitted in the hole 241. The bearing 242 is arranged to rotatably support the first shaft 110.

Once electric currents are supplied to the coils 222 of the stator 220, which is the armature, in the motor 200 having the above-described structure, action of electromagnetic induction causes the first shaft 110 to rotate in the θ direction.

3. Structure of Speed Reducer

The structure of the speed reducer 300 will now be described below with reference to FIG. 2. The speed reducer 300 is a strain wave gearing device arranged to transfer rotation from the first shaft 110 to a second shaft 120, which is a rotating shaft arranged to extend in the x direction, while changing the speed of the rotation. The speed reducer 300 includes a housing 301, an internal gear 302, an external gear 303, and a wave generator 310.

The first shaft 110 is arranged to extend in the x direction from the cover 240, and the wave generator 310 is connected to one end of the first shaft 110. The wave generator 310 includes a cam 304 and a flexible bearing 305.

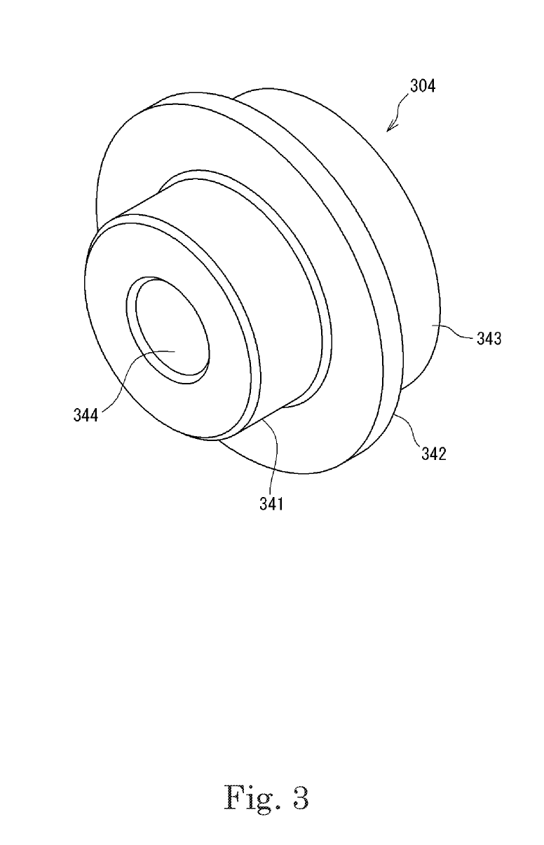

The cam 304 is fixed to one end portion of the first shaft 110. FIG. 3 is a perspective view illustrating an exterior of the cam 304. The cam 304 includes a small diameter portion 341 and a large diameter portion 342 arranged in the x direction. Each of the small diameter portion 341 and the large diameter portion 342 is arranged to have a circular exterior centered on the central axis 111 of the first shaft 110, and the large diameter portion 342 is arranged to have an outside diameter greater than that of the small diameter portion 341. The large diameter portion 342 is arranged closer to the motor 200 than is the small diameter portion 341. An outer circumferential portion of the large diameter portion 342 includes an elliptical decreased diameter portion 343, and the flexible bearing 305 is fitted to the decreased diameter portion 343 (see FIG. 2).

The cam 304 includes a connection hole 344 defined in a center thereof in the r directions. The one end portion of the first shaft 110 is housed in the connection hole 344, and the one end portion of the first shaft 110 is fixed in the connection hole 344 (see FIG. 2). This allows the cam 304 to rotate in the θ direction together with the first shaft 110.

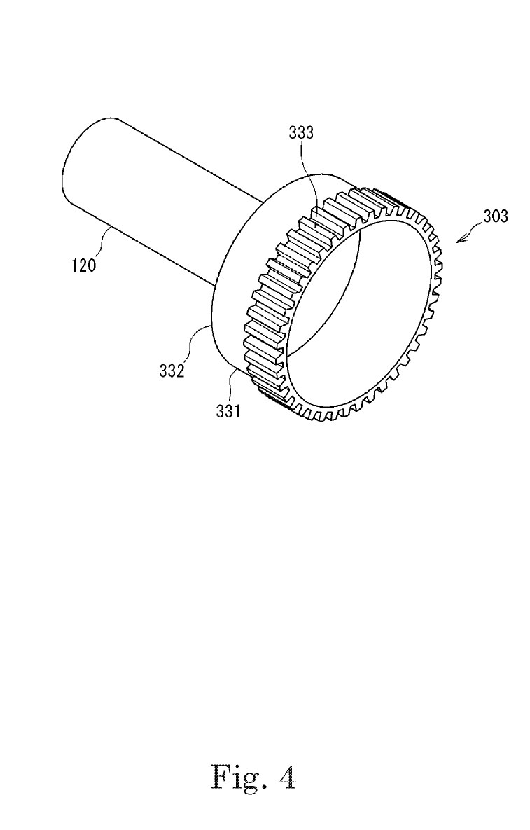

FIG. 4 is a perspective view illustrating an exterior of the external gear 303. The external gear 303 is a cup-shaped external gear which is closed at one end and open at another end in the x direction. That is, the external gear 303 includes a cylindrical portion 331 and a disk-shaped cover portion 332, and the cover portion 332 is arranged to close one end of the cylindrical portion 331. The cylindrical portion 331 is a thin cylinder made of a metal, such as, for example, carbon steel, and is flexible. The cylindrical portion 331 includes an external tooth portion 333 at another end thereof, more specifically, at an outer circumference of an end portion thereof closer to the motor 200.

The cover portion 332 includes surfaces on both sides in the x direction, and the second shaft 120 is arranged to extend in the x direction from a center in the r directions of one of the surfaces of the cover portion 332 on an opposite side to the surface thereof on which the cylindrical portion 331 is arranged. The external gear 303 is arranged to be coaxial with the first shaft 110, and the second shaft 120 and the first shaft 110 are arranged coaxially in series (see FIG. 2). The second shaft 120 is fixed to the cover portion 332, and is arranged to rotate in the 6 direction together with the cover portion 332.

Reference will now be made to FIG. 2. The cam 304 is housed in the cylindrical portion 331 of the external gear 303. The flexible bearing 305 is arranged between an inner circumferential surface of the cylindrical portion 331 of the external gear 303 and the decreased diameter portion 343 (i.e., an outer circumferential surface) of the cam 304. This allows the external gear 303 and the cam 304 to rotate in the 6 direction relative to each other. The flexible bearing 305 includes a flexible outer race member 351, a flexible inner race member 352, and a plurality of balls 353 housed between the outer race member 351 and the inner race member 352, and is capable of being deformed in the r directions.

The cam 304 is a metal block made of, for example, carbon steel, and is arranged to have a high rigidity. Thus, the flexible bearing 305, which is attached to the cam 304, is fitted to an outer circumferential surface of the decreased diameter portion 343 of the cam 304, and is deformed into an elliptical shape. In addition, since an inner circumferential surface of the external gear 303 is in contact with the flexible bearing 305, the cylindrical portion 331 of the external gear 303 is fitted to an outer circumferential surface of the flexible bearing 305, and is deformed into an elliptical shape.

Similarly to the casing 230 of the motor 200, the housing 301 is arranged to have a shape being a combination of a semicircle and a rectangle when viewed in the x direction (see FIG. 1). In other words, the housing 301 includes a semicircular portion 311 and a flange portion 312, which are semicircular and rectangular, respectively, when viewed in the x direction. The semicircular portion 311 is arranged to have a diameter equal to that of the semicircular portion 235 of the casing 230, and the flange portion 312 includes two right-angled corner portions 313 each of which projects in an r direction. The shape of the flange portion 312 of the housing 301 and the shape of the flange portion 236 of the casing 230 match each other, and the flange portion 312 and the flange portion 236 are fixed to each other through the bolts.

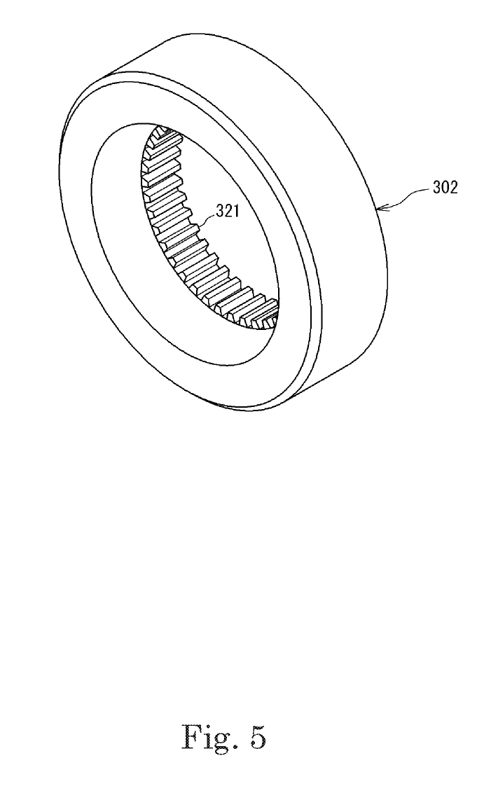

In addition, referring to FIG. 2, the housing 301 has an interior space having a circular section, and the internal gear 302 is housed in this interior space. FIG. 5 is a perspective view illustrating an example exterior of the internal gear 302. The internal gear 302 is in the shape of a circular ring, and is press fitted into the interior space of the housing 301. The housing 301 and the internal gear 302 are fixed to each other. The internal gear 302 includes an internal tooth portion 321 defined in an inner circumference thereof.

Reference will now be made to FIG. 2. The external gear 303 is arranged inside of the internal gear 302. As mentioned above, the external gear 303 is deformed into a shape being elliptical when viewed in the x direction. Accordingly, teeth of the external tooth portion 333 of the external gear 303 which correspond to a major axis mesh with the internal tooth portion 321 of the internal gear 302, while teeth of the external tooth portion 333 which correspond to a minor axis are apart from the internal tooth portion 321.

The number of teeth of the internal tooth portion 321 of the internal gear 302 is different from the number of teeth of the external tooth portion 333 of the external gear 303. For example, when n denotes a positive integer, the number of teeth of the internal tooth portion 321 is arranged to be greater than the number of teeth of the external tooth portion 333 by 2n. Once the first shaft 110 starts rotating, the cam 304 starts rotating together with the first shaft 110. The rotation of the cam 304 causes the external gear 303 to be elastically deformed such that the major axis of the elliptical shape rotates. Accordingly, meshing positions between the external tooth portion 333 and the internal tooth portion 321 move in the 6 direction. That is, the wave generator 310 causes the external gear 303 to be deformed in accordance with the rotation of the first shaft 110 such that meshing positions between the internal gear 302 and the external gear 303 shift in the 6 direction. Every time the first shaft 110 completes a single rotation, the external gear 303 rotates in the 6 direction by an amount corresponding to a difference between the number of teeth of the internal tooth portion 321 and the number of teeth of the external tooth portion 333. As a result, the rotation of the first shaft 110 is transferred to the second shaft 120 while the speed of the rotation is reduced.

A bearing 306 is attached to the housing 301, and the bearing 306 is arranged to support the second shaft 120 such that the second shaft 120 is capable of rotating about the central axis 111. In addition, a washer 307 and a disk-shaped plate member 308 are attached to the second shaft 120 such that the bearing 306, the washer 307, and the plate member 308 are arranged in the x direction.

4. Structure of Gear Mechanism

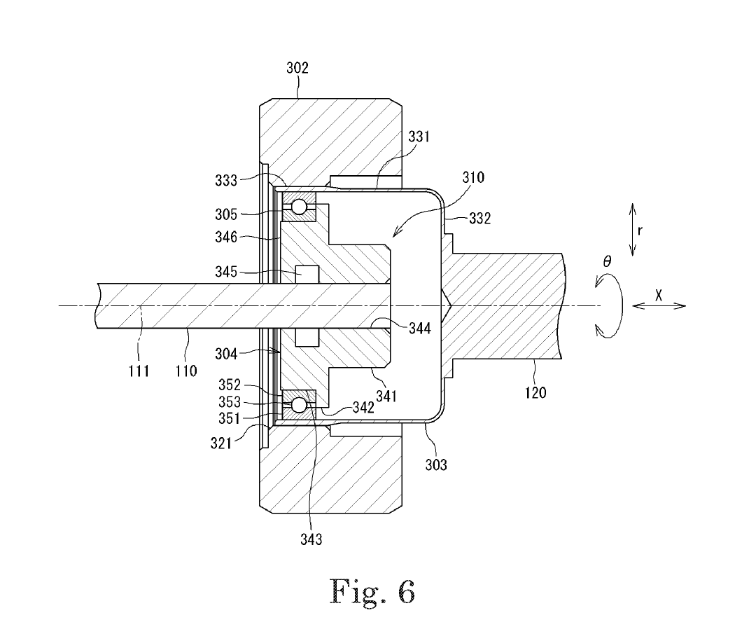

FIG. 6 is a partial side sectional view illustrating the structure of a gear mechanism of the speed reducer according to the present preferred embodiment in an enlarged form. The cam 304 includes the connection hole 344, which is arranged to extend in the x direction, and the one end portion of the first shaft 110 is housed in the connection hole 344. An inner circumferential surface of the cam 304 defining the connection hole 344 includes a recessed portion 345 recessed in the r directions. The recessed portion 345 is arranged in the shape of a circular ring, extending 360 degrees in the θ direction along the inner circumferential surface of the cam 304 defining the connection hole 344.

An example of the recessed portion 345 is illustrated in FIG. 6. This example recessed portion 345 is arranged between both ends of the cam 304 in the x direction. More specifically, the recessed portion 345 is arranged at an intermediate portion of the connection hole 344 in the x direction. Still more specifically, the recessed portion 345 is defined in the large diameter portion 342 of the cam 304.

The recessed portion 345 is arranged opposite to the external tooth portion 333 of the external gear 303 in the r directions. More specifically, in the preferred embodiment illustrated in FIG. 6, the recessed portion 345 is arranged opposite to a portion of the external tooth portion 333 in the r directions. That is, the external tooth portion 333 is arranged on straight lines extending in the r directions from the position of the recessed portion 345. In other words, a range over which the recessed portion 345 extends in the x direction overlaps with a range over which the external tooth portion 333 extends in the x direction.

The diameter of the connection hole 344 before a portion of the first shaft 110 is housed therein is slightly smaller than the diameter of the first shaft 110. The first shaft 110 is press fitted into the connection hole 344 having such a dimension, and the first shaft 110 and the cam 304 are thus connected to each other. When the first shaft 110 is press fitted into the connection hole 344, the shape of an outer circumference of the first shaft 110 can be transferred to the cam 304 to slightly deform the shape of an outer circumference of the cam 304. However, in the range over which the recessed portion 345 extends in the x direction, the cam 304 and the first shaft 110 are not in contact with each other, and the shape of the outer circumference of the first shaft 110 is not transferred to the cam 304. Therefore, in the range over which the recessed portion 345 extends in the x direction, the likelihood of a deformation of the shape of the outer circumference of the cam 304 is reduced.

The flexible bearing 305 is arranged between the recessed portion 345 and the external tooth portion 333. That is, the flexible bearing 305 is arranged opposite to each of the recessed portion 345 and the external tooth portion 333 in the r directions. Therefore, the flexible bearing 305 is arranged at a portion of the outer circumference of the cam 304 where the likelihood of a deformation of the shape of the outer circumference of the cam 304 is reduced, and the external tooth portion 333 is deformed into an elliptical shape matching the shape of the outer circumference of the cam 304 through the flexible bearing 305. Accordingly, an influence of the shape of the outer circumference of the first shaft 110 on the shape of the external tooth portion 333 is reduced to prevent a deterioration in accuracy with which the internal gear 302 and the external gear 303 mesh with each other.

The depth of the recessed portion 345, that is, the dimension of the recessed portion 345 measured in the r directions, is equal to or smaller than a half of a maximum thickness, measured in the r directions, of a portion of the cam 304 which extends over a range over which the cam 304 is joined to the flexible bearing 305, that is, a portion of the cam 304 which corresponds to the decreased diameter portion 343. This contributes to ensuring a sufficient mechanical strength of the cam 304 while avoiding an excessive reduction in the thickness, measured in the r directions, of a portion of the cam 304 in which the recessed portion 345 is defined.

5. Example Modifications

Speed reducers according to example modifications of the present preferred embodiment will now be described below.

5-1. First Modification

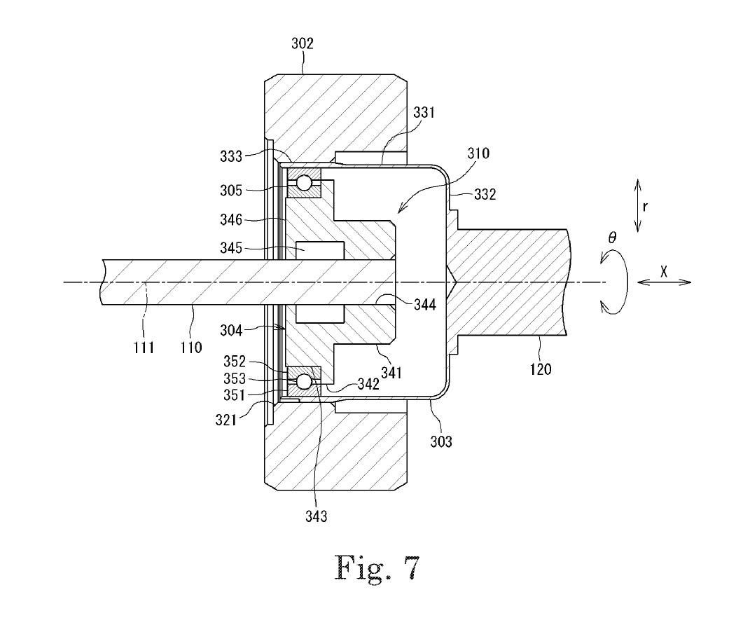

FIG. 7 is a partial side sectional view illustrating the structure of a gear mechanism of a speed reducer according to a first modification of the above-described preferred embodiment in an enlarged form. In this modification, an external tooth portion 333 is arranged apart from an opening end of an external gear 303 in the x direction. In addition, in a cam 304, a recessed portion 345 is arranged to extend over a range including a portion of a small diameter portion 341 and a portion of a large diameter portion 342 in the x direction. A portion of the recessed portion 345 is arranged opposite to the entire external tooth portion 333 in the r directions. In other words, a range over which the external tooth portion 333 extends in the x direction is included in the range over which the recessed portion 345 extends in the x direction.

This contributes to preventing a deformation of an outer circumference of the cam 304 caused by a first shaft 110 from affecting the shape of the entire external tooth portion 333. This in turn contributes to more effectively preventing a deterioration in meshing between an internal gear 302 and the external gear 303.

5-2. Second Modification

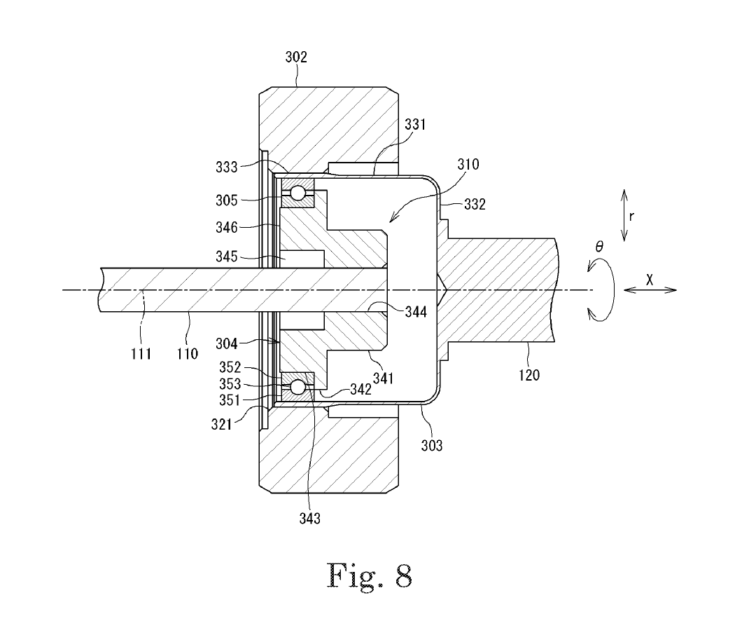

FIG. 8 is a partial side sectional view illustrating the structure of a gear mechanism of a speed reducer according to a second modification of the above-described preferred embodiment in an enlarged form. In this modification, an external tooth portion 333 is arranged at an opening end portion of an external gear 303. In addition, in a cam 304, a recessed portion 345 is arranged to extend over a range from an intermediate point in a connection hole 344 in the x direction to an end portion 346 of the cam 304 on a side on which a large diameter portion 342 lies. That is, the recessed portion 345 is arranged to be open at the end portion 346 of the cam 304 on the side on which the large diameter portion 342 lies. A first shaft 110 is arranged to extend in the x direction over a range including the end portion 346.

Thus, the first shaft 110 and the cam 304 are not in contact with each other over a range extending up to an end of the cam 304 on the side on which the large diameter portion 342, in which the recessed portion 345 is defined, lies, and this contributes to more effectively preventing a deformation of the shape of an outer circumference of the cam 304. In addition, connection of the first shaft 110 to the cam 304 is made easier because the connection hole 344 is widely open at the end of the cam 304 on the side on which the large diameter portion 342 lies.

5-3. Third Modification

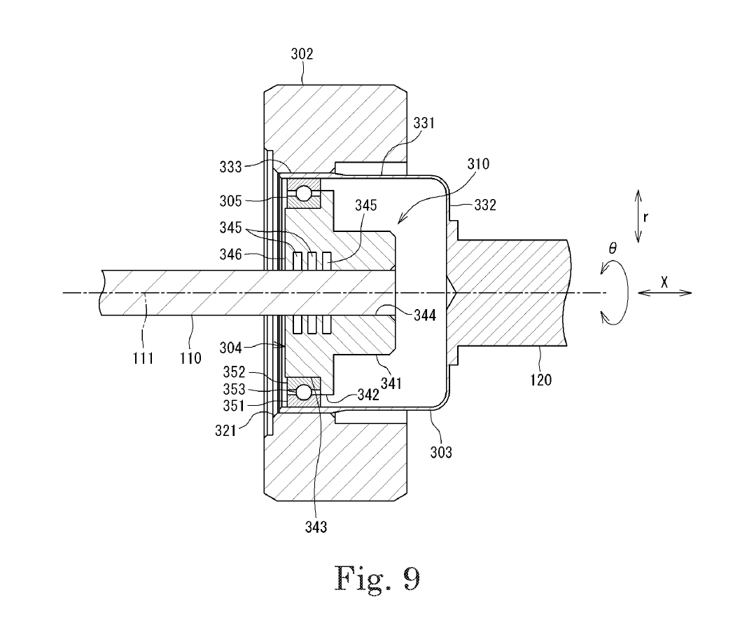

FIG. 9 is a partial side sectional view illustrating the structure of a gear mechanism of a speed reducer according to a third modification of the above-described preferred embodiment in an enlarged form. In this modification, a plurality of recessed portions 345, which are arranged in the x direction, are defined in an inner circumferential surface of a cam 304 defining a connection hole 344. Each recessed portion 345 is arranged opposite to an external tooth portion 333 in the r directions.

This contributes to more effectively preventing a deformation of the shape of an outer circumference of the cam 304. In addition, connection of a first shaft 110 to the cam 304 is made easier because the total area of contact between the cam 304 and the first shaft 110 in the connection hole 344 is reduced.

5-4. Fourth Modification

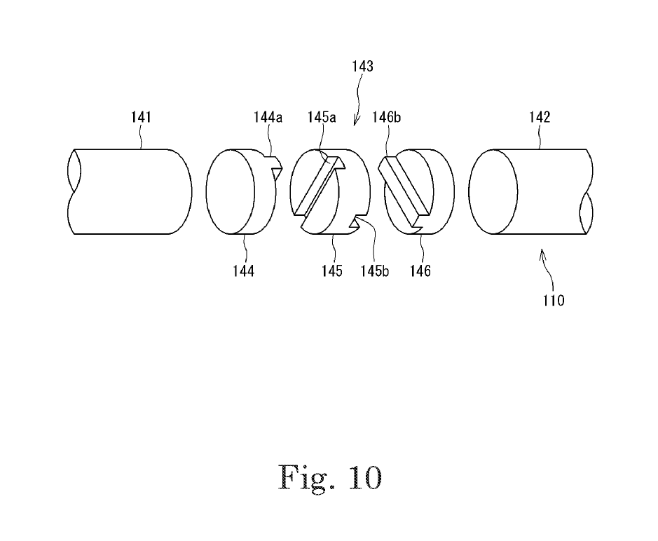

FIG. 10 is an exploded perspective view illustrating the structure of a first shaft 110 of a speed reducer according to a fourth modification of the above-described preferred embodiment. The first shaft 110 according to the present modification includes a first component shaft 141, a second component shaft 142, and a flexible shaft coupling 143. The first component shaft 141 is connected to a cam 304 with one end of the first component shaft 141 being housed in a connection hole 344 of the cam 304. The second component shaft 142 is fixed to a yoke 211 of a rotor 210 of a motor 200. The flexible shaft coupling 143 is arranged to couple the first component shaft 141 and the second component shaft 142 to each other.

The flexible shaft coupling 143 is an Oldham coupling including a first member 144, a second member 145, and a third member 146, and is arranged to couple the two component shafts to each other such that the component shafts are capable of rotating while permitting a misalignment of rotation centers of the component shafts. The first member 144 is a disk-shaped member, and one surface of the first member 144 is connected to an end surface of the first component shaft 141, while another surface of the first member 144 includes a key 144a elongated in an r direction. The second member 145 is a disk-shaped member having a diameter equal to that of the first member 144, and includes a key groove 145a elongated in the r direction in one surface thereof. The one surface of the second member 145 is arranged to face the other surface of the first member 144, and the key 144a is fitted in the key groove 145a. The key groove 145a is arranged to have a width slightly greater than that of the key 144a, and the first member 144 and the second member 145 are capable of sliding in the r direction along the key 144a relative to each other.

In addition, the second member 145 includes a key groove 145b elongated in an r direction in another surface thereof. The direction in which the key groove 145b extends is perpendicular to the direction in which the key groove 145a extends. The third member 146 is a disk-shaped member, and includes a key 146b elongated in the r direction in one surface thereof. The one surface of the third member 146 is arranged to face the other surface of the second member 145, and the key 146b is fitted in the key groove 145b. The key groove 145b is arranged to have a width slightly greater than that of the key 146b, and the second member 145 and the third member 146 are capable of sliding in the r direction along the key 146b relative to each other. The third member 146 is connected to an end surface of the second component shaft 142 at another surface thereof.

Even when a misalignment of the rotation centers of the first component shaft 141 and the second component shaft 142 occurs, the above-described configuration allows the first member 144, the second member 145, and the third member 146 to slide relative to one another in an r direction to absorb the misalignment of the rotation centers, allowing transfer of rotation between the first component shaft 141 and the second component shaft 142. Thus, a precise alignment of the rotation centers of the first component shaft 141 and the second component shaft 142 is not required, resulting in improved assembling workability. Note that the flexible shaft coupling 143 is not limited to the Oldham coupling, but may alternatively be a flexible shaft coupling having another structure, such as, for example, a spring-type flexible shaft coupling.

5-5. Fifth Modification

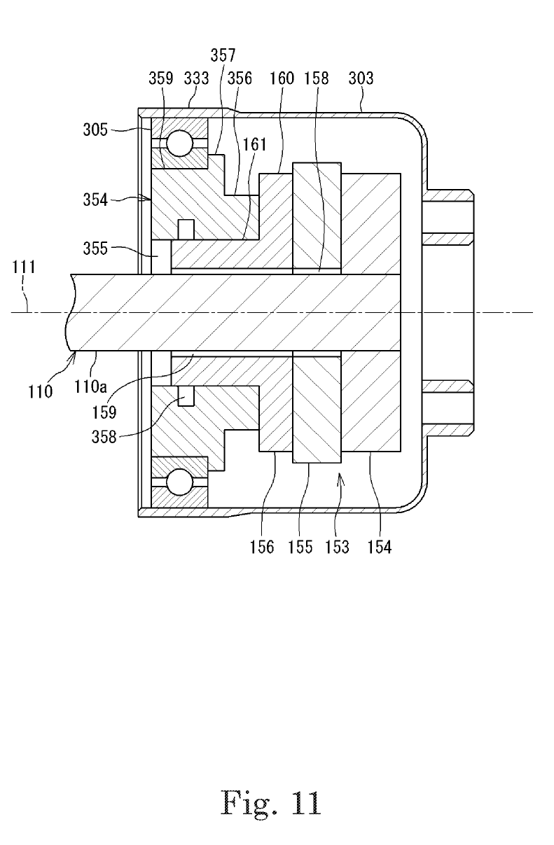

FIG. 11 is a partial side sectional view illustrating the structure of a gear mechanism of a speed reducer according to a fifth modification of the above-described preferred embodiment in an enlarged form. A first shaft 110 according to this modification includes a shaft body 110a and a flexible shaft coupling 153 arranged on one end portion of the shaft body 110a.

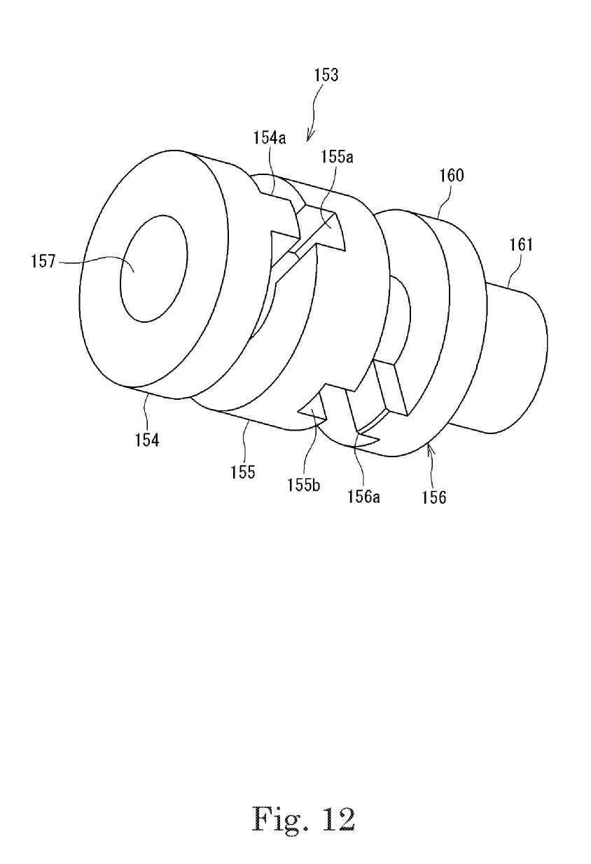

The flexible shaft coupling 153 is an Oldham coupling including a first member 154, a second member 155, and a third member 156, and is arranged to couple the first shaft 110 and a cam 354 to each other such that the first shaft 110 and the cam 354 are capable of rotating while permitting a misalignment of rotation centers of the first shaft 110 and the cam 354. FIG. 12 is an exploded perspective view illustrating the structure of the flexible shaft coupling 153. The first member 154 is a member in the shape of a circular ring, and includes a connection hole 157 in a center thereof. One end portion of the shaft body 110a is press fitted into the connection hole 157. In addition, the first member 154 includes a key 154a elongated in an r direction in one surface thereof.

The second member 155 is a member in the shape of a circular ring. The second member 155 is arranged to have an outside diameter equal to that of the first member 154, and an inside diameter slightly greater than that of the first member 154. That is, the second member 155 includes a hole 158 having a diameter greater than that of the shaft body 110a (see FIG. 11). In addition, the second member 155 includes a key groove 155a elongated in the r direction in one surface thereof. The one surface of the second member 155 is arranged to face the one surface of the first member 154, and the key 154a is fitted in the key groove 155a. The key groove 155a is arranged to have a width slightly greater than that of the key 154a, and the second member 155 is capable of sliding in the r direction along the key 154a with respect to the first member 154 as far as an inner circumferential surface of the second member 155 does not interfere with the shaft body 110a.

In addition, the second member 155 includes a key groove 155b elongated in an r direction in another surface thereof. The direction in which the key groove 155b extends is perpendicular to the direction in which the key groove 155a extends.

The third member 156 is an annular member including a large diameter portion 160 and a small diameter portion 161, and includes a circular hole 159 having a diameter greater than that of the shaft body 110a (see FIG. 11). Each of the large diameter portion 160 and the small diameter portion 161 is in the shape of a circular ring, and the large diameter portion 160 is arranged to have an outside diameter greater than that of the small diameter portion 161. The hole 159 is arranged to pass through both the large diameter portion 160 and the small diameter portion 161. In addition, the third member 156 includes a key 156a in an end surface of the large diameter portion 160. The end surface of the large diameter portion 160 of the third member 156 is arranged to face the other surface of the second member 155, and the key 156a is fitted in the key groove 155b. The key groove 155b is arranged to have a width slightly greater than that of the key 156a, and the second member 155 and the third member 156 are capable of sliding in the r direction along the key groove 155b relative to each other as far as the inner circumferential surface of the second member 155 and an inner circumferential surface of the third member 156 do not interfere with the shaft body 110a.

Referring to FIG. 11, the cam 354 is annular and has an elliptical exterior, and includes a circular connection hole 355. The cam 354 includes a small diameter portion 356 and a large diameter portion 357 arranged in the x direction. Each of the small diameter portion 356 and the large diameter portion 357 is arranged to have a circular exterior centered on a central axis 111 of the first shaft 110, and the large diameter portion 357 is arranged to have an outside diameter greater than that of the small diameter portion 356. The large diameter portion 357 is arranged closer to a motor 200 than is the small diameter portion 356. An outer circumferential portion of the large diameter portion 357 includes an elliptical decreased diameter portion 359, and a flexible bearing 305 is fitted to the decreased diameter portion 359. An end surface of the cam 354 on a side on which the small diameter portion 356 lies is arranged to be in contact with an end surface of the large diameter portion 160 of the third member 156, and the small diameter portion 161 is housed in the connection hole 355. An inner circumferential surface of the cam 354 defining the connection hole 355 includes a recessed portion 358 recessed in the r directions. The recessed portion 358 is arranged in the shape of a circular ring, extending 360 degrees in the θ direction along the inner circumferential surface of the cam 354 defining the connection hole 355.

An example of the recessed portion 358 is illustrated in FIG. 11. This example recessed portion 358 is arranged between both ends of the cam 354 in the x direction. More specifically, the recessed portion 358 is arranged at an intermediate portion of the connection hole 355 in the x direction. Still more specifically, the recessed portion 358 is arranged to overlap with at least a portion of the decreased diameter portion 359 of the cam 354 when viewed in the r directions.

The recessed portion 358 is arranged opposite to an external tooth portion 333 of an external gear 303 in the r directions. More specifically, in the modification illustrated in FIG. 11, the recessed portion 358 is arranged opposite to a portion of the external tooth portion 333 in the r directions. That is, the external tooth portion 333 is arranged on straight lines extending in the r directions from the position of the recessed portion 358. In other words, a range over which the recessed portion 358 extends in the x direction overlaps with a range over which the external tooth portion 333 extends in the x direction.

The diameter of the connection hole 355 before the small diameter portion 161 of the third member 156 is housed therein is slightly smaller than the outside diameter of the small diameter portion 161. The small diameter portion 161 is press fitted into the connection hole 355, so that the third member 156 and the cam 354 are connected to each other. When the small diameter portion 161 is press fitted into the connection hole 355, the shape of an outer circumference of the small diameter portion 161 can be transferred to the cam 354 to slightly deform the shape of an outer circumference of the cam 354. However, in the range over which the recessed portion 358 extends in the x direction, the cam 354 and the small diameter portion 161 are not in contact with each other, and the shape of the outer circumference of the small diameter portion 161 is not transferred to the cam 354. Therefore, in the range over which the recessed portion 358 extends in the x direction, the likelihood of a deformation of the shape of the outer circumference of the cam 354 is reduced.

The flexible bearing 305 is arranged between the recessed portion 358 and the external tooth portion 333. That is, the flexible bearing 305 is arranged opposite to each of the recessed portion 358 and the external tooth portion 333 in the r directions. Therefore, the flexible bearing 305 is arranged at a portion of the outer circumference of the cam 354 where the likelihood of a deformation of the shape of the outer circumference of the cam 354 is reduced, and the external tooth portion 333 is deformed into an elliptical shape in accordance with the shape of the outer circumference of the cam 354 through the flexible bearing 305. Accordingly, an influence of the shape of the outer circumference of the small diameter portion 161 on the shape of the external tooth portion 333 is reduced to prevent a deterioration in accuracy with which an internal gear 302 and the external gear 303 mesh with each other.

The depth of the recessed portion 358, that is, the dimension of the recessed portion 358 measured in the r directions, is equal to or smaller than a half of a maximum thickness, measured in the r directions, of a portion of the cam 354 which extends over a range over which the cam 354 is joined to the flexible bearing 305, that is, a portion of the cam 304 which corresponds to the decreased diameter portion 359. This contributes to ensuring a sufficient mechanical strength of the cam 354 while avoiding an excessive reduction in the thickness, measured in the r directions, of a portion of the cam 354 in which the recessed portion 358 is defined.

Even when a misalignment of the rotation centers of the first shaft 110 and the cam 354 occurs, the above-described configuration allows the first member 154, the second member 155, and the third member 156 to slide relative to one another in an r direction to absorb the misalignment of the rotation centers, allowing transfer of rotation between the first shaft 110 and the cam 354. Thus, a precise alignment of the rotation centers of the first shaft 110 and the cam 354 is not required, resulting in improved assembling workability. Note that the flexible shaft coupling 153 is not limited to the Oldham coupling, but may alternatively be a flexible shaft coupling having another structure, such as, for example, a spring-type flexible shaft coupling.

5-6. Other Example Modifications

In the actuator 100 according to the above-described preferred embodiment of the present invention, the first shaft 110 is connected to the motor 200, which is an example of a rotary electric machine. Note, however, that actuators according to other preferred embodiments of the present invention may have another structure. In another preferred embodiment of the present invention, an electric generator, which is another example of a rotary electric machine, may be connected to a first shaft 110. In yet another preferred embodiment of the present invention, a second shaft 120 may be connected to a rotary electric machine, such as, for example, a motor, an electric generator, or a motor generator.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A transmission comprising:
a first shaft that is rotatable in a circumferential direction about a central axis extending in one direction;
a second shaft that is rotatable in the circumferential direction, and arranged in series with the first shaft in an axial direction in which the central axis extends;
an internal gear including an internal tooth portion;
a housing that houses the internal gear therein;
an annular external gear connected to the second shaft, and including an external tooth portion that partially meshes with the internal tooth portion;
a cam that is rotatable together with the first shaft, and including a connection hole that houses a portion of the first shaft; and
a bearing located between an inner circumferential surface of the external gear and an outer circumferential surface of the cam; wherein
the cam includes an inner circumferential surface defining the connection hole, and including a recessed portion recessed in radial directions centered on the central axis; and
at least a portion of the recessed portion is opposite to the external tooth portion in the radial directions.

2. The transmission according to claim 1, wherein the recessed portion has a depth equal to or smaller than a half of a maximum thickness, measured in the radial directions, of a portion of the cam which extends over an area in which the cam is joined to the bearing.

3. The transmission according to claim 1, wherein at least a portion of the recessed portion is opposite to an entirety of the external tooth portion in the radial directions.

4. The transmission according to claim 1, wherein the recessed portion is arranged to be open at an end of the cam in the axial direction.

5. The transmission according to claim 1, wherein the cam includes a plurality of the recessed portions arranged in the axial direction in the inner circumferential surface defining the connection hole.

6. The transmission according to claim 1, wherein the first shaft includes:
a first component shaft connected to the cam;
a second component shaft extending in a direction parallel or substantially parallel to the first component shaft; and
a flexible shaft coupling arranged to couple the first and second component shafts to each other such that the first and second component shafts are capable of rotating while permitting a misalignment of rotation centers of the first and second component shafts.

7. The transmission according to claim 1, wherein
the first shaft includes a flexible shaft coupling arranged to couple the first shaft and the cam to each other such that the first shaft and the cam are capable of rotating while permitting a misalignment of rotation centers of the first shaft and the cam; and
the connection hole houses a portion of the flexible shaft coupling.

8. An actuator comprising:
the transmission of claim 1; and
a rotary electric machine connected to one of the first shaft and the second shaft.
